(19) United States
(12) Patent Application Publication
(10) Pub. No.: US 2025/0364846 A1
(43) Pub. Date: Nov. 27, 2025

(54) Magnetic Alignment Structures for a Wireless Power Transfer System

(71) Applicant: Apple Inc., Cupertino, CA (US)

(72) Inventors: Ruiyang Lin, Milpitas, CA (US); Grant S Haug, San Francisco, CA (US)

(21) Appl. No.: 19/182,390

(22) Filed: Apr. 17, 2025

Related U.S. Application Data
(60) Provisional application No. 63/650,219, filed on May 21, 2024.

(51) Int. Cl. H02J 50/90; H02J 50/10; H02J 50/40; H02J 50/70

(52) U.S. Cl. CPC H02J 50/90; H02J 50/10; H02J 50/402; H02J 50/70

(57) ABSTRACT

A wireless power transfer system that includes a power transmitting device and one or more power receiving devices of varying types is provided. The power transmitting device can include a first wireless power transfer coil configured to transmit wireless power to a power receiving device of a first type, a second wireless power transfer coil configured to transmit wireless power to a power receiving device of a second type, and a magnetic alignment structure. The magnetic alignment structure can be operable in a first state or position when the power receiving device of the first type is disposed on a charging surface of the power transmitting device and can be operable in a second state or position when the power receiving device of the second type is disposed on the charging surface.

This application claims the benefit of U.S. Provisional Patent Application No. 63/650,219, filed May 21, 2024, which is hereby incorporated by reference herein in its entirety.

### FIELD

This relates generally to power systems, including wireless power systems for charging electronic devices.

### BACKGROUND

In a wireless charging system, a power transmitting device such as a charging puck can transmit wireless power to a power receiving device such as a battery-powered, portable electronic device. The power transmitting device has a coil that produces electromagnetic flux. The power receiving device has a coil and rectifier circuitry that uses electromagnetic flux produced by the power transmitting device to generate direct-current power for powering electrical loads in the battery-powered portable electronic device. It can be challenging to design a wireless charging system.

### SUMMARY

An aspect of the disclosure provides a power transmitting device that includes a first wireless power transfer coil configured to transmit wireless power to a power receiving device of a first type, a second wireless power transfer coil configured to transmit wireless power to a power receiving device of a second type different than the first type, and a magnetic alignment structure configured to shift to a first position within the power transmitting device when the power receiving device of the first type is on a charging surface of the power transmitting device and shift to a second position, different than the first position, within the power transmitting device when the power receiving device of the second type is on the charging surface. The power transmitting device can further include a magnetic shunt disposed on a housing portion and providing a magnetic force to pull the magnetic alignment structure to the second position when the power receiving device of the second type is on the charging surface. The power transmitting device can include one or more guide structures at least partially surrounding the magnetic alignment structure and configured to guide the magnetic alignment structure between the first and second positions.

An aspect of the disclosure provides a power transmitting device that includes a first wireless power transfer coil configured to transmit wireless power to a first power receiving device of a first type, a second wireless power transfer coil configured to transmit wireless power to a second power receiving device of a second type different than the first type, and a magnetic alignment structure. The magnetic alignment structure can be configured to attract a corresponding magnet in the first power receiving device while the first wireless power transfer coil is transmitting wireless power to the first power receiving device and permit the second wireless power transfer coil to transmit wireless power to the second power receiving device without saturating a magnetic shield in the second power receiving device.

An aspect of the disclosure provides an electronic device that includes a first wireless power transfer coil configured to transmit wireless power to a first power receiving device, a second wireless power transfer coil configured to transmit wireless power to a second power receiving device, and a magnetic alignment structure operable in a first state when the first power receiving device is disposed on a charging surface of the electronic device and a second state when the second power receiving device is disposed on the charging surface. In the first state, the magnetic alignment structure can be configured to attract a corresponding magnet in the first power receiving device. In the second state, the magnetic alignment structure can be configured to permit the second wireless power transfer coil to transmit wireless power to the second power receiving device without saturating a magnetic shield in the second power receiving device.

### BRIEF DESCRIPTION OF THE DRAWINGS

FIG. 1 is a block diagram of an illustrative wireless power transfer system in accordance with some embodiments.

FIG. 2 is a side view of an illustrative power transmitting device configured to transmit wireless power to a power receiving device of a first type in accordance with some embodiments.

FIG. 3 is a side view of an illustrative power transmitting device configured to transmit wireless power to a power receiving device of a second type in accordance with some embodiments.

FIG. 4 is a side view of an illustrative power transmitting device having a magnetic alignment structure operable in a first state in accordance with some embodiments.

FIG. 5 is a side view of an illustrative power transmitting device having a magnetic alignment structure operable in a second state in accordance with some embodiments.

FIG. 6A is a perspective view of an illustrative magnetic alignment structure having a south pole facing a charging surface of a power transmitting device in accordance with some embodiments.

FIG. 6B is a perspective view of an illustrative magnetic alignment structure having a north pole facing a charging surface of a power transmitting device in accordance with some embodiments.

FIG. 7A is a top (plan) view of an illustrative magnetic alignment structure having a first shape and having north and south poles facing a charging surface of a power transmitting device in accordance with some embodiments.

FIG. 7B is a top (plan) view of an illustrative magnetic alignment structure having a second shape and having north and south poles facing a charging surface of a power transmitting device in accordance with some embodiments.

FIG. 8 is an exploded view showing wireless power transfer coils and magnetic alignment structures within a power transmitting device in accordance with some embodiments.

### DETAILED DESCRIPTION

A wireless power transfer system can include a power transmitting device configured to transmit wireless power to one or more wireless power receiving devices. The wireless power receiving devices may include electronic devices such as wristwatches, cellular telephones, tablet computers, laptop computers, ear buds, battery cases for ear buds and other devices, tablet computer styluses (pencils) and other input-output devices, wearable devices, head-mounted devices, or other electronic equipment. The power transmitting device may be an electronic device such as a wireless charging mat or puck, a tablet computer or other battery-powered electronic device with wireless power transmitting circuitry, or other wireless power transmitting device. The power receiving devices use power from the power transmitting device for powering internal components and for charging an internal battery. Because transmitted wireless power is often used for charging internal batteries, wireless power transmission operations are sometimes referred to as wireless charging operations.

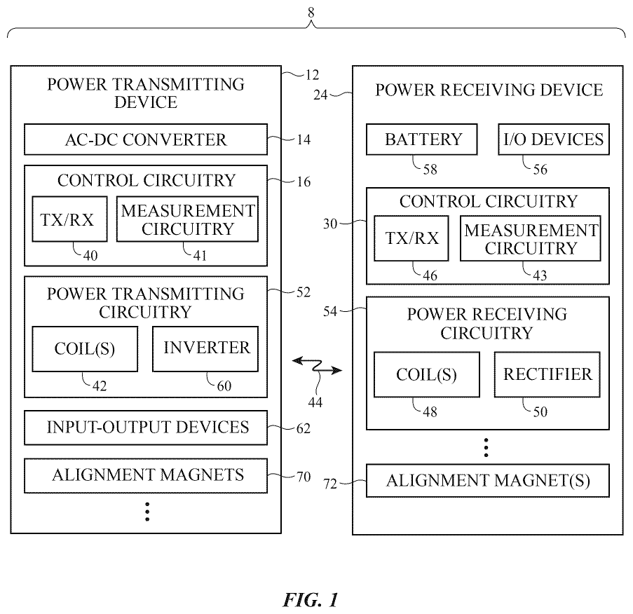

An illustrative wireless power transfer system 8, sometimes referred to as a wireless charging system, is shown in FIG. 1. As shown in FIG. 1, wireless power transfer system 8 can include a power transmitting device such as wireless power transmitting device 12 and a power receiving device such as wireless power receiving device 24. Wireless power transmitting device 12 includes control circuitry 16. Wireless power receiving device 24 includes control circuitry 30. Control circuitries in system 8 such as control circuitry 16 and control circuitry 30 are used in controlling the operation of system 8. This control circuitry may include processing circuitry associated with microprocessors, power management units, baseband processors, application processors, digital signal processors, microcontrollers, battery chargers, and/or application-specific integrated circuits with processing circuits. The processing circuitry implements desired control and communications features in devices 12 and 24.

For example, the processing circuitry may be used in selecting wireless power coils, determining power transmission levels, processing sensor data and other data, processing user input, handling negotiations between devices 12 and 24, sending and receiving in-band and out-of-band data, making measurements, and otherwise controlling the operation of system 8. As another example, the processing circuitry may include one or more processors such as an application processor that is used to run software such as internet browsing applications, voice-over-internet-protocol (VOIP) telephone call applications, email applications, media playback applications, operating system functions, power management functions for controlling when one or more processors wake up, game applications, maps, instant messaging applications, payment applications, calendar applications, notification/reminder applications, and so forth.

Control circuitry in system 8 may be configured to perform operations in system 8 using hardware (e.g., dedicated hardware or circuitry), firmware and/or software. Software code for performing operations in system 8 is stored on non-transitory computer readable storage media (e.g., tangible computer readable storage media) in control circuitry 8. The software code may sometimes be referred to as software, data, program instructions, instructions, or code. The non-transitory computer readable storage media may include non-volatile memory such as non-volatile random-access memory (NVRAM), one or more hard drives (e.g., magnetic drives or solid state drives), one or more removable flash drives or other removable media, or the like. Software stored on the non-transitory computer readable storage media may be executed on the processing circuitry of control circuitry 16 and/or 30. The processing circuitry may include application-specific integrated circuits with processing circuitry, one or more microprocessors such as an application processor, a central processing unit (CPU) or other processing circuitry.

Wireless power transmitting device 12 may be a stand-alone power adapter (e.g., a wireless charging mat or puck that includes power adapter circuitry), may be a wireless charging mat or puck that is coupled to a power adapter or other equipment by a cable, may be a battery-powered electronic device (cellular telephone, tablet computer, laptop computer, removable case, etc.), may be equipment that has been incorporated into furniture, a vehicle, or other system, or may be other wireless power transfer equipment. Illustrative configurations in which wireless power transmitting device 12 is a wireless charging puck or battery-powered electronic device are sometimes described herein as an example.

Wireless power receiving device 24 may be a portable electronic device such as a wristwatch, a cellular telephone, a laptop computer, a tablet computer, an accessory such as an earbud, a tablet computer input device such as a wireless tablet computer stylus (pencil), a battery case, or other electronic equipment. Wireless power transmitting device 12 may include one or more input-output devices 62 (e.g., input devices and/or output devices of the type described in connection with input-output devices 56) or input-output devices 62 may be omitted (e.g., to reduce device complexity). Wireless power transmitting device 12 may be coupled to a wall outlet (e.g., an alternating current power source), may have a battery for supplying power, and/or may have another source of power. Device 12 may have an alternating-current (AC) to direct-current (DC) power converter such as AC-DC power converter 14 for converting AC power from a wall outlet or other power source into DC power.

In some configurations, AC-DC power converter 14 may be provided in an enclosure (e.g., a power brick enclosure) that is separate from the enclosure of device 12 (e.g., a wireless charging puck enclosure or battery-powered electronic device enclosure) and a cable may be used to couple DC power from the power converter to device 12. DC power may be used to power control circuitry 16. During operation, a controller in control circuitry 16 may use power transmitting circuitry 52 to transmit wireless power to power receiving circuitry 54 of device 24. Power transmitting circuitry 52 may have switching circuitry (e.g., inverter circuitry 60 formed from transistors) that is turned on and off based on control signals provided by control circuitry 16 to create AC current signals through one or more transmit coils 42. Coils 42 may be arranged in a planar coil array (e.g., in configurations in which device 12 is a wireless charging mat) or may be arranged to form a cluster of coils (e.g., in configurations in which device 12 is a wireless charging puck). In some arrangements, device 12 (e.g., a charging mat, puck, battery-powered device, etc.) may have only a single coil. In other arrangements, wireless charging device 12 may have multiple coils (e.g., two or more coils, 5-10 coils, at least 10 coils, 10-30 coils, fewer than 35 coils, fewer than 25 coils, or other suitable number of coils).

As the AC currents pass through one or more coils 42, the coils 42 produce electromagnetic field signals 44 in response to the AC current signals. Electromagnetic field signals (sometimes referred to as wireless power signals) 44 can then induce a corresponding AC current to flow in one or more nearby receiver coils such as coil 48 in power receiving device 24. When the alternating-current electromagnetic fields are received by coil 48, corresponding alternating-current currents are induced in coil 48. Rectifier circuitry such as rectifier 50, which contains rectifying components such as synchronous rectification metal-oxide-semiconductor transistors arranged in a bridge network, converts received AC signals (received alternating-current signals associated with electromagnetic field 44) from coil 48 into DC voltage signals for powering loads in device 24 such powering application processors as well as charging a battery in the device. This principle of wireless power transfer can be referred to as the transmitting and receiving of wireless power signals.

The DC voltages produced by rectifier 50 can be used in powering an energy storage device such as battery 58 and can be used in powering other components in device 24. For example, device 24 may include input-output devices 56 such as a display, touch sensor, communications circuits, audio components, sensors, components that produce electromagnetic signals that are sensed by a touch sensor in tablet computer or other device with a touch sensor (e.g., to provide stylus input), and other components and these components may be powered by the DC voltages produced by rectifier 50, in combination with other available energy sources such as battery 58.

During wireless power transmission operations, power transmitting circuitry 52 can supply AC drive signals such as AC current signals to one or more coils 42 at a given power transmission frequency. The power transmission frequency is sometimes referred to as a carrier frequency, power carrier frequency, drive frequency, or inverter switching frequency Fs. The inverter switching frequency Fs may be, for example, a predetermined frequency of about 125 kHz, about 128 kHz, about 200 kHz, about 326 kHz, about 360 kHz, at least 80 kHz, at least 100 kHz, less than 500 kHz, less than 300 kHz, or other suitable wireless power frequency. Devices operating under the Qi wireless charging standard established by the Wireless Power Consortium generally operate between 110-205 kHz or between 80-300 kHz. In some configurations, the switching frequency Fs is negotiated in communications between devices 12 and 24. In other configurations, the power transmission frequency can be fixed.

Control circuitry 16 may also include external object measurement circuitry 41 configured to detect external objects on a charging surface of device 12 and to make other desired measurements such as current measurements, voltage measurements, power measurements, and/or energy measurements. Measurement circuitry 41 can detect indications of objects abutting device 12. Measurement circuitry 41 can aid in the detection of whether a nearby object is compatible with wireless charging operations, or if the nearby object is likely a foreign object such as coils, paper clips, coins, and other generally metallic objects that react to inductive fields but incompatible with wireless charging.

During wireless power transfer operations, while power transmitting circuitry 52 is driving AC signals onto one or more of coils 42 to produce signals 44 at the power transmission frequency, wireless transceiver circuitry 40 uses frequency-shift keying (FSK) modulation to modulate the power transmission frequency of the driving AC signals and thereby modulate the frequency of signals 44. Power receiving circuitry 54 uses the received signals on coil 48 and rectifier 50 to produce DC power. At the same time, wireless transceiver circuitry 46 uses FSK demodulation to extract the transmitted in-band data from signals 44. This approach allows FSK data (e.g., FSK data packets) to be transmitted in-band from device 12 to device 24 via coils 42 and 48 while wireless power is simultaneously being conveyed from device 12 to device 24 via coils 42 and 48. Transceiver circuitry 46 may be coupled to coil 48 (e.g., via one or more capacitors). Measurement circuitry 43 may also be coupled to coil 48 or some other node in power receiving circuitry 54 to make impedance measurements, impulse response measurements, and/or other desired measurements for external object detection.

In-band communications between device 24 and device 12 can employ ASK modulation and demodulation techniques. Wireless transceiver circuitry 46 can include an ASK modulator coupled to coil 48 for modulating the impedance of power receiving circuitry 54 (e.g., to adjust the impedance at coil 48). This, in turn, modulates the amplitude of signals 44 and the amplitude of the AC signals passing through coil(s) 42. Transceiver circuitry 40 can include an ASK demodulator for monitoring the amplitude of the AC signals passing through coil(s) 42 and, using ASK demodulation, extracts the transmitted in-band data from these signals that was transmitted by wireless transceiver circuitry 46. The use of ASK communications allows ASK data bits (e.g., ASK data packets) to be transmitted in-band from device 24 to device 12 with coils 48 and 42 while power is simultaneously being wirelessly conveyed from device 12 to device 24 using coils 42 and 48.

Power transmitting device 12 can include one or more alignment magnets such as alignment magnet(s) 70. Power receiving device 24 can include one or more alignment magnets such as alignment magnet(s) 72. Power receiving device 24 can be placed on a charging surface of power transmitting device 12. When power receiving device 24 is disposed on the charging surface of power transmitting device 12, alignment magnet(s) 70 may attract or exhibit a magnetic force that pulls on the corresponding alignment magnet(s) 72 in power receiving device 24. Operated in this way, alignment magnets 70 and 72 can be configured to orient devices 12 and 24 in a way such that coil 42 of device 12 is substantially aligned with coil 48 of device 24 for promoting efficient wireless power transfer. Alignment magnets 70 and 72 of such type are sometimes referred to herein as magnetic alignment structures.

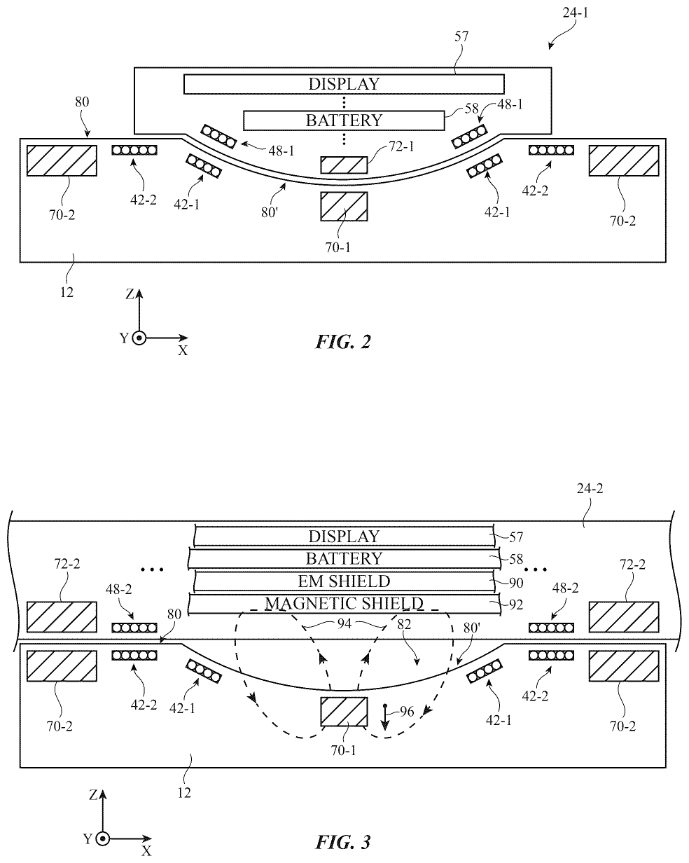

Power transmitting device 12 may be operable to transmit wireless power to one or more types of power receiving devices 24. FIG. 2 is a side view of power transmitting device 12 being configured to transmit wireless power to a power receiving device of a first type (e.g., device 24-1). Device 24-1 may, for example, be a wristwatch or other type of portable electronic device. As shown in FIG. 2, power receiving device 24-1 may be disposed on a charging surface 80 of power transmitting device 12. Power receiving device 24-1 may have a curved housing portion, and the power transmitting device 12 may have a corresponding curved surface portion 80′ configured to receive the curved housing portion of power receiving device 24-1 (e.g., the curvature of portion 80′ of the charging surface may be substantially matched with the curvature of the curved housing portion of device 24-1). The curved surface portion 80′ of power transmitting device 12 of the type shown in FIG. 2 is sometimes referred to as a concave surface or an inward-curving surface. The curved surfaces of power transmitting device 12 and the power receiving device 24-1 are illustrative. In other embodiments, the mating surfaces of power transmitting device 12 and power receiving device 24-1 can be planar or non-curving.

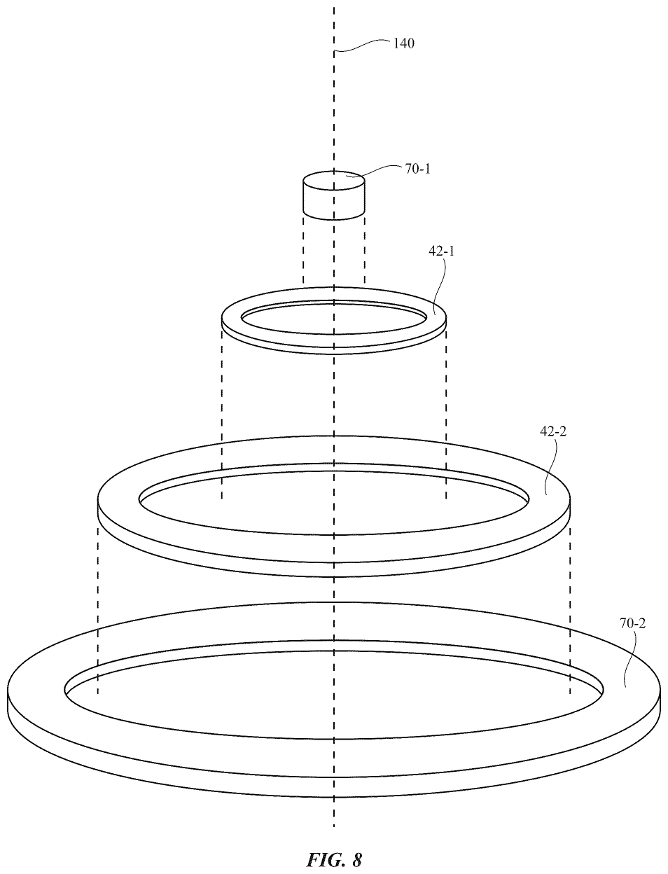

Power transmitting device 12 may include a first wireless power transfer coil 42-1, a second wireless power transfer coil 42-2, a first magnetic alignment structure 70-1, and a second magnetic alignment structure 70-2. The first wireless power transfer coil 42-1, second wireless power transfer coil 42-2, first magnetic alignment structure 70-1, and second magnetic alignment structure 70-2 can be concentric structures. This concentric arrangement is illustrated in FIG. 8. As shown in the exploded view of FIG. 8, the first wireless power transfer coil 42-1 may be a first circular coil structure having a center aligned with axis 140; the second wireless power transfer coil 42-2 may be a second circular coil structure wider than first wireless power transfer coil 42-1 and having a center aligned with axis 140 (e.g., coil 42-2 may surround coil 42-1 within device 12); the first magnetic alignment structure 70-1 may be a cylindrical structure having a center aligned with axis 140 (e.g., magnet 70-1 may be surrounded by coil 42-1 within device 12); and the second magnetic alignment structure 70-2 may be a circular structure having a center aligned with axis 140 (e.g., structure 70-2 may surround coil 42-2 within device 12). Axis 140 in FIG. 8 may be parallel to the Z-axis in FIG. 2.

The example of FIG. 8 in which magnetic alignment structure 70-1 has a cylindrical shape/structure is illustrative. In general, magnetic alignment structure 70-1 can have a circular cross section as shown in FIG. 8, a rectangular cross section, an oval cross section, a pentagonal cross section, a hexagonal cross section, an octagonal cross section, or can have other suitable shapes. Although magnetic alignment structure 70-2 is shown as one contiguous circular structure in FIG. 8, magnetic alignment structure 70-2 can, in general, be formed from one or more magnets (e.g., a ring of magnets).

Referring back to FIG. 2, when power receiving device 24-1 is received on charging surface 80 of power transmitting device 12, the curved housing portion of device 24-1 can fit into the curved surface portion 80′ of device 12. In particular, magnet 72-1 within power receiving device 24-1 can be configured to attract or exhibit a magnetic force that pulls on corresponding magnetic alignment structure 70-1 within power transmitting device 12. Magnet 72-1 of device 24-1 can also sometimes be referred to as a magnetic alignment structure. This magnetic attraction between magnet 72-1 of device 24-1 and magnetic alignment structure 70-1 of power transmitting device 12 ensures that device 24-1 is properly attached to device 12 during wireless power transfer operations and, more particularly, ensures that the first wireless power transfer coil 42-1 of device 12 is properly aligned with wireless power transfer coil 48-1 of device 24-1 during wireless power transfer (see, e.g., coils 42-1 and 48-1 are substantially overlapping in the side view of FIG. 2). FIG. 2 further illustrates how device 24-1 can include one or more display 57, battery 58, and/or other electronic components within the housing of device 24-1.

Power transmitting device 12 may be operable to transmit wireless power to other types of power receiving devices. FIG. 3 is a side view of power transmitting device 12 being configured to transmit wireless power to a power receiving device of a second type (e.g., device 24-2) different than the first type. Device 24-2 may, for example, be a cellular telephone or other type of portable electronic device. Device 24-2 can represent different versions or generations of a smart phone. As shown in FIG. 3, power receiving device 24-1 may be disposed on charging surface 80 of power transmitting device 12. Unlike power receiving device 24-1, power receiving device 24-2 may have a substantially flat or planar housing that mates with the flat (non-curving) portion of surface 80. Thus, when power receiving device 24-2 is disposed on charging surface 80, there can be an air gap such as gap 82 between device 24-2 and the concave surface portion 80′ of device 12.

FIG. 3 further illustrates how device 24-2 can include one or more display 57, battery 58, shielding layers 90 and 92, and/or other electronic components within the housing of device 24-2. Although not explicitly shown, additional components such as communications, storage, and processing components can be included within the stack-up of device 24-2. The arrangements of components within device 24-2 may vary. Electronic components within device 24-2 may be subject to signal interference. Shielding layer 90 can be a metal shield configured to suppress electromagnetic interference. Shielding layer 90 of this type can be formed from materials such as copper, nickel, silver, gold, other metals, a combination of these materials, or other suitable conductive material that suppress signals at radio frequencies and may sometimes be referred to as a radio-frequency (RF) shield or e-shield.

Shielding layer 92 directs magnetic fields at relatively lower frequencies to function as a guide for electromagnetic flux received from power transmitting device 12. Layer 92 may be a layer of magnetic material that serves as a magnetic shield (i.e., layer 92 can block magnetic flux and may have a relative permeability of 500 or more 1000 or more, or other suitable value). An example of a material that can be used in forming magnetic shielding layer 92 is ferrite. Another example of a material that can be used in forming magnetic shielding layer 92 is a high permeability nickel-iron magnetic alloy that is sometimes referred to as mu-metal or permalloy. Another example of a material that can be used in forming magnetic shielding layer 92 is an iron-based nano-crystalline material.

When power receiving device 24-2 is received on charging surface 80 of power transmitting device 12, a magnet 72-2 within power receiving device 24-2 can be configured to attract or exhibit a magnetic force that pulls on corresponding magnetic alignment structure 70-2 within power transmitting device 12. Magnet 72-2 of device 24-2 can also sometimes be referred to as a magnetic alignment structure. The use of magnetic alignment structure 72-2 within device 24-2 is optional. Magnetic alignment structure 72-2 in some devices 24-2 of the second type can be omitted. This magnetic attraction between magnet 72-2 of device 24-2 and magnetic alignment structure 70-2 of power transmitting device 12 ensures that device 24-2 is properly attached to device 12 during wireless charging and, more particularly, ensures that the second wireless power transfer coil 42-2 of device 12 is properly aligned with wireless power transfer coil 48-2 of device 24-2 during wireless charging (see, e.g., coils 42-2 and 48-2 are substantially overlapping in the side view of FIG. 3).

When power receiving device 24-2 is disposed on the charging surface 80 of power transmitting device 12, if care is not taken, the magnetic alignment structure 70-1 of device 12 can produce DC magnetic flux (see, e.g., magnetic flux lines 94) that may contribute to certain characteristic conditions in magnetic shielding layer 92 within power receiving device 24-2. During wireless power transmission, AC current signals flowing through coil 42-2 can induce AC magnetic flux that can add to the DC magnetic flux associated with magnetic alignment structure 70-1 within device 12. The combination of the AC and DC magnetic flux at power transmitting device 12 can result in a characteristic condition such as saturation at magnetic shield 92. Saturation of a material occurs when an increase in applied magnetic field cannot further increase the magnetization of the material. Saturation can also occur at ferrite or nano-crystalline materials with high magnetic saturation or high AC flux. In examples where magnetic shield 92 is a ferrite structure, such saturation is sometimes referred to and defined herein as ferrite saturation. Saturation (e.g., magnetic saturation or magnetic flux saturation) can impact wireless charging performance. As an example, the impact can include reduced inductance between device 12 and device 24-2 when device 24-2 is disposed on the charging surface of device 12.

In accordance with an embodiment, to reduce the risk of saturation at magnetic shield 92, the magnetic alignment structure 70-1 can be configured in different states depending on whether power transmitting device 12 is currently attached to power receiving device 24-1 of the first type or to power receiving device 24-2 of the second type. In the example of FIG. 3, magnetic alignment structure 70-1 can be shifted further away from the charging surface of device 12 (as indicated by the direction of arrow 96) when device 24-2 is disposed on device 12. Shifting magnetic alignment structure 70-1 further away from the charging surface in this way can be technically advantageous and beneficial to reduce or mitigate saturation at magnetic shield 92 within device 24-2 during wireless power transfer operations.

The embodiments shown in FIGS. 2 and 3 in which power transmitting device 12 includes both coil 42-1 and coil 42-2 are exemplary. Coil 42-1 and/or coil 42-2 can optionally be omitted from power transmitting device 12. For example, power transmitting device 12 might include coil 42-1 without having coil 42-2 (e.g., coil 42-2 can be omitted from device 12). As another example, power transmitting device might include coil 42-2 without having coil 42-1 (e.g., coil 42-1 can be omitted from device 12). In general, power transmitting device 12 can include one or more wireless power transfer coil(s) having a center that is aligned to the position of magnetic alignment structure 70-1.

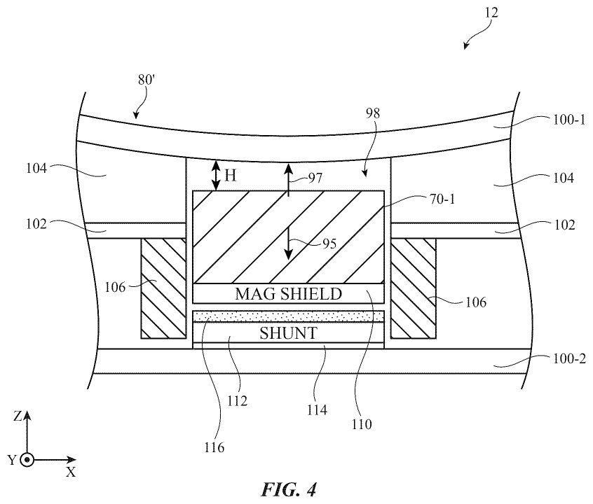

FIG. 4 is a side view of a portion of power transmitting device 12 that includes magnetic alignment structure 70-1. As shown in FIG. 4, magnetic alignment structure 70-1 may be disposed between an upper housing 100-1 and a lower housing 100-2. Upper housing 100-1 is sometimes referred to as an upper housing portion, whereas lower housing 100-2 is sometimes referred to as a lower housing portion. The upper housing portion 100-1 may have a convex or inward-curving surface such as curved surface portion 80′. Device 12 may include a substrate layer such as printed circuit board (PCB) 102. Circuit board 102 may include a through hole, opening, or cutout through which magnetic alignment structure 70-1 can be disposed within device 12.

One or more support structures such as support structures 104 can be disposed on a first (upper) surface of circuit board 102. Support structures 104 can optionally be implemented as a magnetic structure (e.g., a ferrite structure) for containing or directing the magnetic flux from magnetic alignment structure 70-1 or can be implemented as a non-magnetic structure (e.g., plastic or other types of polymer). On the other side, one or more support structures such as support (wall) structures 106 can be disposed on a second (lower) surface of circuit board 102. Support structures 106 can optionally be implemented as a magnetic structure (e.g., a ferrite or magnetic steel structure) for containing or directing the magnetic flux from magnetic alignment structure 70-1 or can be implemented as a non-magnetic structure (e.g., plastic or other types of polymer). Support structures 104 and 106 can collectively form a wall surrounding magnetic alignment structure 70-1, which can serve as a track for guiding the movement of magnetic alignment structure 70-1 as it is shifted in the Z direction.

A magnetic shielding layer such as magnetic shielding layer 110 can be disposed on a lower surface of magnetic alignment structure 70-1. Magnetic shield 110 can serve as a DC shield (e.g., formed from magnetic steel or ferrite) for directing flux from magnetic alignment structure 70-1 upwards so that the flux will not leak towards lower housing 100-2.

A magnetic shunt such as magnetic shunt 112 can be disposed on the lower housing 100-2 directly under magnetic alignment structure 70-1. A layer of adhesive such as pressure-sensitive adhesive 114 can be disposed between magnetic shunt 112 and lower housing 100-2. If desired, other types of adhesive or mechanism(s) for attaching magnetic shunt 112 to the lower housing 100-2 can be employed.

In some embodiments, an impact absorption layer such as impact absorption layer 116 can be disposed on an upper surface of magnetic shunt 112 facing the magnetic alignment structure 70-1. Impact absorption layer 116 can be implemented as a foam layer (as an example) or other soft or absorbent material. Impact absorption layer 116 can be configured to absorb a physical impact resulting from magnetic alignment structure 70-1 being shifted downwards in the direction of arrow 95 towards magnetic shunt 112. Layer 116 can also help mitigate any sound that might result from such physical impact and is thus sometimes referred to as a sound absorption layer. If desired, an additional impact absorption layer can optionally be disposed on the inner surface of upper housing 100-1 directly above structure 70-1 to absorb the impact of magnetic alignment structure 70-1 as it moves towards upper housing 100-1 in the direction of arrow 97.

Magnetic shunt 112 can be configured to attract or exhibit a magnetic force that pulls on magnetic alignment structure 70-1 so that magnetic alignment structure 70-1 is shifted downwards in the direction of arrow 95 when no external device is attached to device 12. Thus, when no external device is disposed on the charging surface of device 12, magnetic alignment structure 70-1 may be shifted downwards until pressing against magnetic shunt 112. Magnetic shunt 112 configured to pull magnetic alignment structure 70-1 downwards in this way can sometimes be referred to as a return shunt.

This state in which magnetic alignment structure 70-1 is pressing against magnetic shunt 112 is sometimes referred to and defined herein as a “retracted” state. In the retracted state, an air gap such as gap 98 may be present between the magnetic alignment structure 70-1 and upper housing 100-1. Air gap 98 may have a height H that allows magnetic alignment structure 70-1 to travel with sufficient displacement along the Z axis such that magnetic alignment structure 70-1 does not produce saturation in device 24-2 when device 24-2 is attached to device 12. Height H may be around 0.5 mm, 0.4-0.6 mm, 0.5-1 mm, 1-2 mm, 1-3 mm, 1-5 mm, 5-10 mm, or other distance. Preventing saturation in this way can be technically advantageous and beneficial to improve wireless power transfer efficiency.

When device 24-2 is disposed on the charging surface of power transmitting device 12 (as shown in FIG. 3), magnetic shunt 112 may be configured to pull magnetic alignment structure 70-1 to the retracted state. In the retracted state, magnetic alignment structure 70-1 may be positioned sufficiently far from the charging surface to permit second wireless power transfer coil 42-2 to transmit wireless power to corresponding coil 48-2 in device 24-2 without saturating magnetic shield 92. Magnetic alignment structure 70-1 that can be moved or shifted between different positions is in this way is sometimes referred to as a retractable magnet or a retractable magnetic alignment structure.

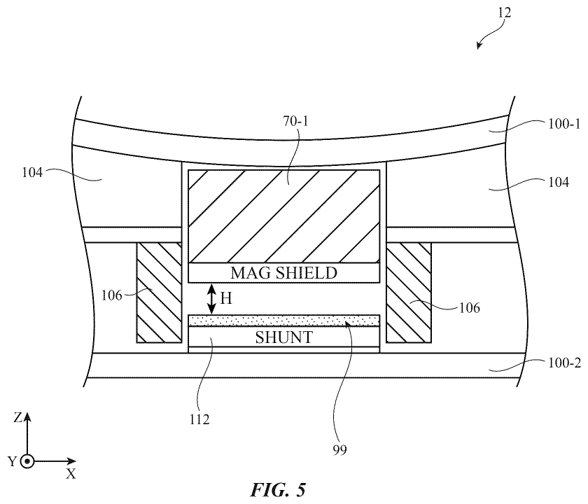

Retractable magnetic alignment structure 70-1 can be operable in a retracted state (position) and a deployed state (position). In the retracted state, magnetic alignment structure 70-1 can press against the lower housing portion of device 12, as shown in FIG. 4. In the deployed state, magnetic alignment structure 70-2 can press against the upper housing portion of device 12, as shown in FIG. 5. FIG. 5 is a side view showing a portion of power transmitting device 12, where magnetic alignment structure 70-1 is configured in the deployed state. As shown in FIG. 5, magnetic alignment structure 70-1 may press against the upper housing 100-1 in the deployed state. In the deployed state, an air gap such as gap 99 may be present between the magnetic alignment structure 70-1 and magnetic shunt 112. Air gap 99 may have a height H that allows magnetic alignment structure 70-1 to travel with sufficient displacement along the Z axis such that magnetic alignment structure 70-1 is able to attract corresponding magnet 72-1 in device 24-1, for aligning the wireless power transfer coils, when device 24-1 is disposed on the charging surface of device 12. Magnetic alignment structure 70-1 should only be in the deployed state of FIG. 5 when device 24-1 of the first type is disposed on power transmitting device 12, as shown in the arrangement of FIG. 2. In other words, when the power receiving device 24-1 of the first type is on the charging surface, magnet 72-1 can overcome the magnetic force from the magnetic shunt 112 to pull magnetic alignment structure 70-1 to the deployed position.

The examples of FIGS. 4 and 5 in which magnetic alignment structure 70-1 is operable between a retracted state and a deployed state are illustrative. In other embodiments, magnetic alignment structure 70-1 need not be a magnet that moves or shifts in the Z direction. If desired, magnetic alignment structure 70-1 can be rotatable about a rotational axis. If desired, magnetic alignment structure 70-1 might be shifted along the XY plane (e.g., in a lateral direction). In yet other embodiments, magnetic alignment structure 70-1 can be operable among three or more different states to support operation with at least three different types of power receiving devices 24.

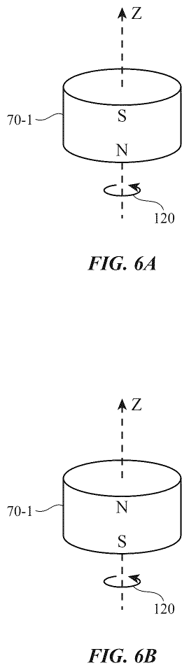

Magnetic alignment structure 70-1 of power transmitting device 12 can have any suitable shape. FIG. 6A illustrates one embodiment in which magnetic alignment structure 70-1 is a cylindrical magnet with a south pole S facing the charging surface of device 12 and a north pole N, opposing the south pole, facing magnetic shunt 112. Configured in this way, magnetic alignment structure 70-1 may be allowed to rotate about the Z axis, as indicated by arrow 120. The guide structures 104 and 106 described in connection with FIG. 4 can form a circular wall for allowing such cylindrical magnet 70-1 to move up and down along the Z axis between the retracted and deployed state while optionally rotating about the Z axis.

The example of FIG. 6A in which cylindrical magnet 70-1 has an upward facing south pole is illustrative. FIG. 6B illustrates another embodiment in which magnetic alignment structure 70-1 is a cylindrical magnet with a north pole N facing the charging surface of device 12 and a south pole S, opposing the north pole, facing magnetic shunt 112. Configured in this way, magnetic alignment structure 70-1 may be allowed to rotate about the Z axis, as indicated by arrow 120. The guide structures 104 and 106 described in connection with FIG. 4 can form a circular wall for allowing such cylindrical magnet 70-1 to move up and down along the Z axis between the retracted and deployed state while optionally rotating about the Z axis.

The examples of FIGS. 6A and 6B in which magnetic alignment structure 70-1 is allowed to rotate about the Z axis are illustrative. In other embodiments, magnetic alignment structure 70-1 may have north and south poles facing the charging surface of device 12. A magnetic alignment structure oriented in this way should not be allowed to rotate assuming the orientation of the north and south poles matters for the attraction mechanism between device 12 and the corresponding power receiving device 24.

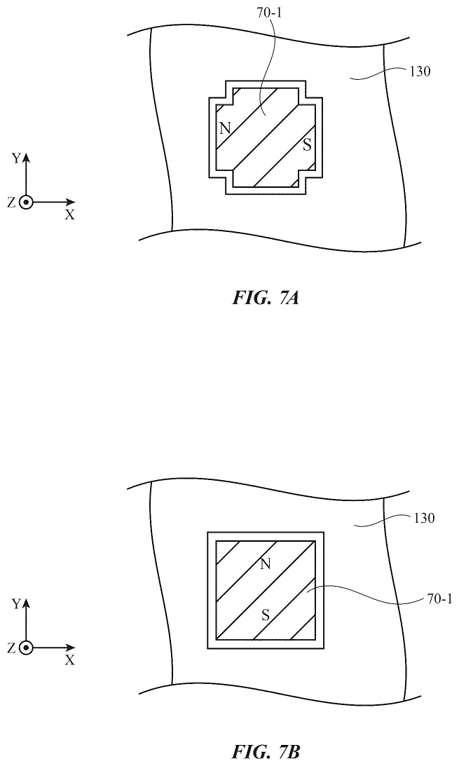

FIG. 7A is a top (plan) view of exemplary magnetic alignment structure 70-1 having a first shape and having north and south poles facing the charging surface of device 12. As shown in the example of FIG. 7A, structure 130, which can represent structure 102, 104, 106, or other guide structures in the stackup within device 12, can have an opening or cutout that matches the shape of magnetic alignment structure 70-1. Having a cutout that matches the shape of the magnetic alignment structure 70-1 can help ensure that magnet 70-1 does not rotate about the Z axis. Structure 130 can form a wall for allowing magnet 70-1 of FIG. 7A to move up and down along the Z axis between the retracted and deployed state without rotating about the Z axis.

The shape of magnet 70-1 in FIG. 7A is illustrative. FIG. 7B is a top (plan) view of exemplary magnetic alignment structure 70-1 having a second shape and having north and south poles facing the charging surface of device 12. As shown in the example of FIG. 7B, structure 130, which can represent structure 102, 104, 106, or other guide structures in the stackup within device 12, can have a square or rectangular opening/cutout that matches the shape of magnetic alignment structure 70-1. Having a cutout that matches the shape of the magnetic alignment structure 70-1 can help ensure that magnet 70-1 does not rotate about the Z axis. Structure 130 can form a wall for allowing magnet 70-1 of FIG. 7B to move up and down along the Z axis between the retracted and deployed state without rotating about the Z axis.

The square shape of magnet 70-1 in the example of FIG. 7B is illustrative. In general, magnetic alignment structure 70-1 can have an oval shape, pentagonal shape, hexagonal shape, octagonal shape, a shaped with only curved edges, a shape with only straight edges, a shape with a combination or curved and straight edges, or other suitable shape(s).

The foregoing is merely illustrative and various modifications can be made to the described embodiments. The foregoing embodiments may be implemented individually or in any combination.

What is claimed is:

1. A power transmitting device comprising:
a first wireless power transfer coil configured to transmit wireless power to a power receiving device of a first type;
a second wireless power transfer coil configured to transmit wireless power to a power receiving device of a second type different than the first type; and
a magnetic alignment structure configured to:
shift to a first position within the power transmitting device when the power receiving device of the first type is on a charging surface of the power transmitting device; and
shift to a second position, different than the first position, within the power transmitting device when the power receiving device of the second type is on the charging surface.

2. The power transmitting device of claim 1, further comprising:
a magnetic shielding layer disposed on a first surface of the magnetic alignment structure, wherein the magnetic alignment structure has a second surface, opposing the first surface, facing the charging surface.

3. The power transmitting device of claim 1, wherein the magnetic alignment structure is disposed between the charging surface and a housing portion of the power transmitting device, further comprising:
a magnetic shunt disposed on the housing portion and providing a magnetic force to pull the magnetic alignment structure to the second position when the power receiving device of the second type is on the charging surface.

4. The power transmitting device of claim 3, wherein when the power receiving device of the first type is on the charging surface, a magnet in the power receiving device of the first type overcomes the magnetic force from the magnetic shunt to pull the magnetic alignment structure to the first position.

5. The power transmitting device of claim 3, further comprising:
an impact absorption layer disposed on a first surface of the magnetic shunt.

6. The power transmitting device of claim 3, further comprising:
an adhesive layer disposed between the magnetic shunt and the housing portion.

7. The power transmitting device of claim 1, further comprising:
one or more guide structures at least partially surrounding the magnetic alignment structure and configured to guide the magnetic alignment structure between the first and second positions.

8. The power transmitting device of claim 1, wherein the magnetic alignment structure comprises a first surface facing the charging surface and a second surface opposing the first surface, and wherein the magnetic alignment structure comprises a north pole either at the first surface or the second surface of the magnetic alignment structure.

9. The power transmitting device of claim 1, wherein the magnetic alignment structure comprises a surface facing the charging surface of the power transmitting device, and wherein the magnetic alignment structure comprises north and south poles on the surface of the magnetic alignment structure.

10. The power transmitting device of claim 1, wherein the magnetic alignment structure is concentric with the first and second wireless power transfer coils.

11. The power transmitting device of claim 10, further comprising:
an additional magnetic alignment structure concentric with the first and second wireless power transfer coils and configured to align the second wireless power transfer coil with a corresponding wireless power transfer coil in the power receiving device of the second type when the power receiving device of the second type is on the charging surface.

12. The power transmitting device of claim 1, wherein:
a first portion of the charging surface is curved and configured to receive a corresponding curved surface of the power receiving device of the first type; and
a second portion of the charging surface is planar and configured to receive a corresponding planar surface of the power receiving device of the second type.

13. The power transmitting device of claim 12, wherein:
the power receiving device of the first type comprises a wristwatch; and
the power receiving device of the second type comprises one or more generations of a phone.

14. A power transmitting device, comprising:
a first wireless power transfer coil configured to transmit wireless power to a first power receiving device of a first type;
a second wireless power transfer coil configured to transmit wireless power to a second power receiving device of a second type different than the first type; and
a magnetic alignment structure configured to:
attract a corresponding magnet in the first power receiving device while the first wireless power transfer coil is transmitting wireless power to the first power receiving device; and
permit the second wireless power transfer coil to transmit wireless power to the second power receiving device without saturating a magnetic shield in the second power receiving device.

15. The power transmitting device of claim 14, wherein the magnetic shield comprises ferrite or an iron-based nano-crystalline material.

16. The power transmitting device of claim 14, wherein:
the magnetic alignment structure is in a first state while the first wireless power transfer coil is transmitting wireless power to the first power receiving device; and
the magnetic alignment structure is in a second state, different than the first state, while the second wireless power transfer coil is transmitting wireless power to the second power receiving device.

17. The power transmitting device of claim 16, further comprising:
a magnetic shunt configured to place the magnetic alignment structure in the second state to prevent saturating the magnetic shield while the second wireless power transfer coil is transmitting wireless power to the second power receiving device.

18. An electronic device comprising:
a first wireless power transfer coil configured to transmit wireless power to a first power receiving device;
a second wireless power transfer coil configured to transmit wireless power to a second power receiving device; and
a magnetic alignment structure operable in:
a first state when the first power receiving device is disposed on a charging surface of the electronic device; and
a second state when the second power receiving device is disposed on the charging surface.

19. The electronic device of claim 18, wherein:
in the first state, the magnetic alignment structure is configured to attract a corresponding magnet in the first power receiving device; and
in the second state, the magnetic alignment structure is configured to permit the second wireless power transfer coil to transmit wireless power to the second power receiving device without saturating a magnetic shield in the second power receiving device.

20. The electronic device of claim 18, wherein:
in the first state, the magnetic alignment structure is configured to press against a first housing portion of the electronic device, the charging surface being part of the first housing portion; and
in the second state, the magnetic alignment structure is configured to press against a second housing portion, opposing the first housing portion, of the electronic device.
